(19) United States
(12) Patent Application Publication
(10) Pub. No.: US 2022/0194191 A1
(43) Pub. Date: Jun. 23, 2022

(54) Openable Vehicle Roof Comprising a Weatherstrip Arrangement on a Solid Roof Element

(71) Applicant: Webasto SE, Stockdorf (DE)

(72) Inventor: Andreas Josef ZUNZER, Stockdorf (DE)

(21) Appl. No.: 17/539,397

(22) Filed: Dec. 1, 2021

(30) Foreign Application Priority Data
Dec. 17, 2020 (DE) 10 2020 134 022.2

(51) Int. Cl. B60J 7/04; B60J 10/15; B60J 10/82

(52) U.S. Cl. CPC B60J 7/04; B60J 10/82; B60J 10/15

(57) ABSTRACT

An openable vehicle roof having a solid roof element, a roof opening and roof opening system having a cover element openable by displacement kinematics. The solid roof having a weatherstrip arrangement at its front edge and its lateral edges disposed on either side of a vertical longitudinal center roof plane, the front edge of the cover element abutting a transverse leg of the weatherstrip arrangement when the cover element is in the closed position, and the displacement kinematics having a kinematic unit on either side of the vertical longitudinal center roof plane, each kinematic unit having a raising lever which slides on a respective longitudinal leg of the weatherstrip arrangement when the cover element is being displaced in the longitudinal roof direction. The longitudinal legs of the weatherstrip arrangement are each connected to the transverse leg via a corner piece made of an elastomer blended with a low-friction additive.

The invention relates to an openable vehicle roof having the features of the preamble of claim 1.

A vehicle roof of this kind is known from practice and is in particular configured as a panoramic roof of a passenger car. The panoramic roof includes a solid roof element which is rigid or immobile relative to the vehicle body and which has a transparent glass element through which light can enter an interior of the vehicle in question. A roof opening is disposed to the rear of the solid roof element, said roof opening being associated with a roof opening system having a cover element which can be displaced between a closed position, in which it closes the roof opening, and an open position, in which the roof opening is at least partially open, by means of displacement kinematics. The displacement kinematics comprise a kinematic unit on either side of a vertical longitudinal center roof plane, each kinematic unit comprising a raising lever which is initially raised when the cover element is being displaced, causing the cover element to be lifted. Then, the raising levers are displaced together with the cover element in the rear direction along a lateral edge of the solid roof element. The solid roof element is provided with a weatherstrip arrangement at its lateral edges with respect to the vertical longitudinal center roof plane and at its front edge, the weatherstrip arrangement thus being at least largely U-shaped. When the cover element is in the closed position, the rear edge of the cover element is in contact with a transverse leg of the weatherstrip arrangement. When the cover element is being displaced in the longitudinal vehicle direction, the raising levers each slide on one of the longitudinal legs of the weatherstrip arrangement, which are disposed at the lateral edges of the solid roof element. in a first movement phase during the opening process, the raising levers strike an area of transition between the transverse leg and the respective longitudinal leg of the weatherstrip arrangement. The resulting shear and abrasion forces acting on the weatherstrip arrangement are very high, which is why the weatherstrip arrangement is provided with an anti-friction coating. However, the application of the anti-friction coating requires a lot of work because the respective areas of the weatherstrip arrangement have to be cleaned and provided with a primer before the anti-friction coating is applied, Additionally, the application of the anti-friction coating has to be followed by a drying process at increased temperatures. The introduction of heat during the drying can compromise the material properties of the weatherstrip arrangement and its geometry. The manual labor and the time needed for applying the anti-friction coating leads to fluctuations in the quality of the resultant weatherstrip arrangement. Moreover, the application of the anti-friction coating leads to additional material cost and labor cost.

The object of the invention is to provide a vehicle roof of the kind mentioned above which is provided with an optimized weatherstrip arrangement on the solid roof element.

is According to the invention, this object is attained by the vehicle roof having the features of claim 1.

So according to the invention, an openable vehicle roof is proposed which comprises a solid roof element, a roof opening disposed forward of the solid roof element, and a roof opening system having a cover element which is configured to be displaced between a closed position, in which the cover element closes the roof opening, and an open position, in which the roof opening is at least partially open, by means of displacement kinematics, The solid roof element is provided with a weatherstrip arrangement at its front. edge and at its lateral edges disposed on either side of a vertical longitudinal center roof plane. The rear edge of the cover element abuts a transverse leg of the weatherstrip arrangement of the solid roof element when the cover element is in the closed position, The displacement kinematics comprise a kinematic unit on either side of the vertical longitudinal center roof plane, each kinematic unit having a raising lever which slides on a respective longitudinal leg of the weatherstrip arrangement when the cover element is being displaced in the longitudinal roof direction. The longitudinal legs of the weatherstrip arrangement are each connected to the transverse leg via a corner piece made of an elastomer blended with a low-friction additive.

The weatherstrip arrangement of the openable vehicle roof according to the invention which is configured according to the invention is a structural unit of at least five jointed elements, namely two longitudinal legs, one transverse leg, and two corner pieces each connecting one of the longitudinal legs to the transverse leg, thereby forming connecting elements, or a structural unit of at least three jointed elements, wherein one corner piece and one longitudinal leg can be produced in one piece in a single process in each case and the corner pieces are connected or molded to the transverse legs. The corner pieces each form a transition between the respective longitudinal leg and the transverse leg and, in the installed position, they are the parts of the weatherstrip arrangement that the raising levers strike first when the cover element is displaced in the rear direction. The forces exerted on the corner piece by the respective raising lever can be counteracted by the fact that the corner pieces are made of an elastomer containing a low-friction additive with the result that an abrasion of the corner pieces and thus their wear can be kept low, especially since the low-friction properties also remain after an abrasion of the surface because the additive can he dispersed in the volume of the elastomer. The low-friction additives or components introduced into the elastomeric base material make painting the corner pieces jointed with the longitudinal legs and the transverse leg of the weatherstrip arrangement with an anti-friction coating after their molding unnecessary. instead, the required sliding properties are provided directly by the material of the corner pieces, which are molded pieces.

In a preferred embodiment of the openable vehicle roof according to the invention, the elastomer that the corner pieces of the weatherstrip arrangement are made of is a thermoplastic elastomer (TPE), preferably a thermoplastic vulcanizate (TPV), In particular, the elastomer can comprise an EPDM (ethylene propylene diene rubber).

The low-friction additive with which the elastomer of the corner pieces or the connect-ing pieces between the longitudinal legs and the transverse leg of the weatherstrip arrangement is provided can be configured in various ways. For example, the low-friction additive comprises graphite, PTFE, PFPE, silicone, polyurethane, polyurethane dispersion, carbon black, an oil, such as in the form of oil droplets, a polyolefin wax, a soap and/or the like.

The longitudinal legs and the transverse leg of the weatherstrip arrangement of the openable vehicle roof according to the invention are preferably each formed by a weatherstrip profile. The cross section or the structure of the weatherstrip profile of the longitudinal legs can differ from that of the transverse leg.

As described above, the corner pieces of the weatherstrip arrangement are molded to the longitudinal legs and the transverse leg, which means that they are connected to them in a form-fitting and material-bonded manner, In an advantageous embodiment of the openable vehicle roof according to the invention, the corner pieces are each connected to one of the longitudinal legs and to the transverse leg by vulcanization.

In another specific embodiment of the openable vehicle roof according to the invention, the longitudinal legs are also each made of an elastomer blended with a low-friction additive. Therefore, painting of the longitudinal legs with an anti-friction coating is unnecessary. The elastomer for producing the longitudinal legs, which are in particular extruded profiles, can be a thermoplastic elastomer (TPE), such as a thermoplastic i5 vulcanizate (TPV). Preferably, the elastomer comprises EPDM. It can contain graphite,

PTFE, PFPE, silicone, polyurethane, polyurethane dispersions, carbon black, an oil, a polyolefin wax, a soap and/or the like as a low-friction additive.

In the same manner, the transverse leg can be made of an elastomer blended with a low-friction additive. A thermoplastic elastomer, in particular a thermoplastic vulcanizate, can again be used as the elastomer. Preferably, the elastomer comprises EPDM. It can contain graphite, PTFE, PFPE, silicone, polyurethane, polyurethane dispersions, carbon black, an oil, a polyolefin wax, a soap and/or the like as the low-friction additive, for example.

It is conceivable for each corner piece and the associated longitudinal leg to be manufacture in one piece in a single process and to be made of the same material in this case.

It is also conceivable for the corner piece and the associated longitudinal leg to be a two-component molded piece.

Other advantages and advantageous configurations of the subject matter of the invention are apparent from the. description, the drawing and the claims.

An example of an embodiment of an openable vehicle roof according to the invention is schematically illustrated in the drawing and will be discussed in more detail in the following description.

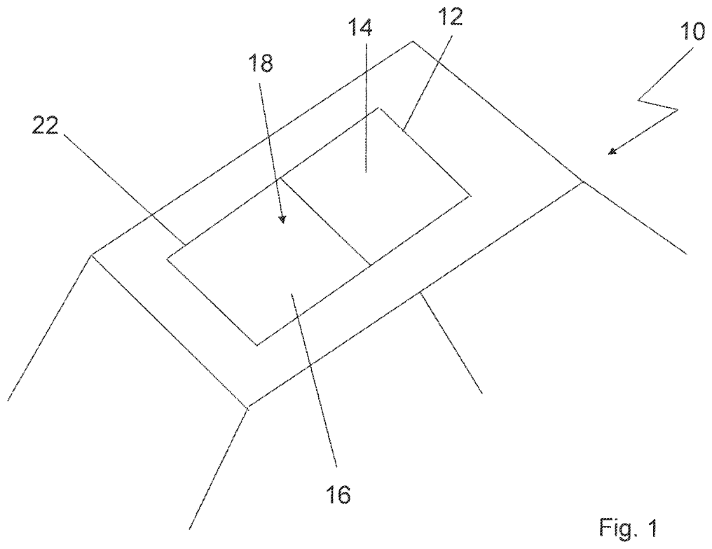

FIG. 1 is a perspective top view of a vehicle roof equipped with a panoramic roof;

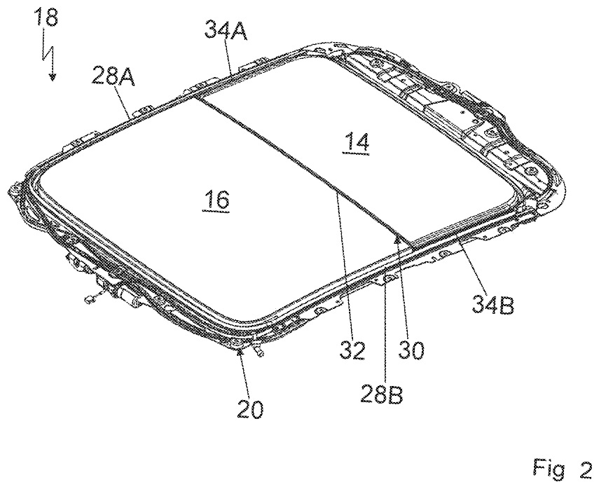

FIG. 2 is a perspective top view of a module-type. insert of the vehicle roof of FIG. 1 with a cover element in a closed position;

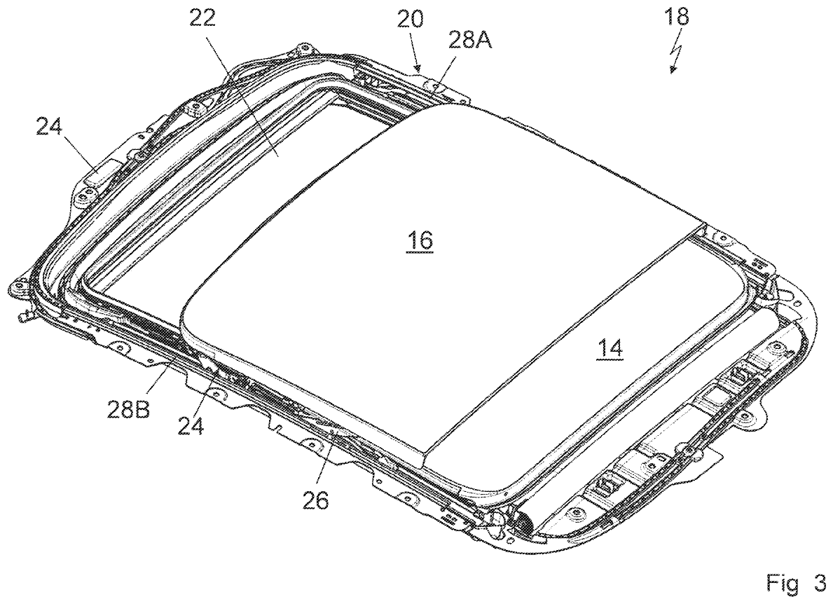

FIG. 3 is a perspective view of the module-type insert of FIG. 2 with the cover element in an open position;

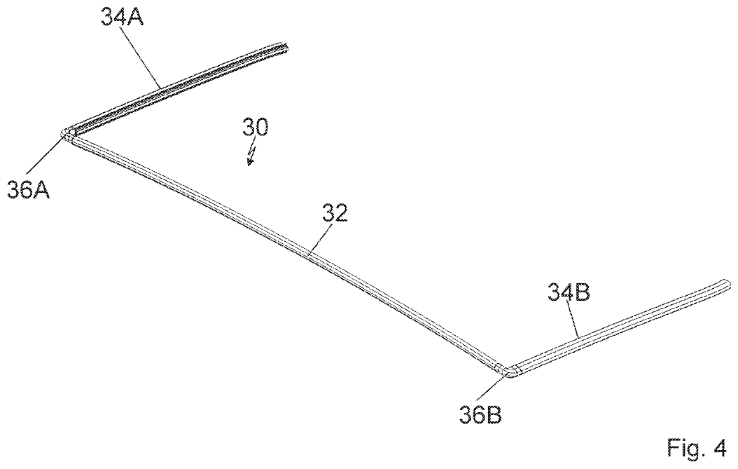

FIG. 4 is a perspective view of a weatherstrip arrangement of a solid roof element of the vehicle roof; and

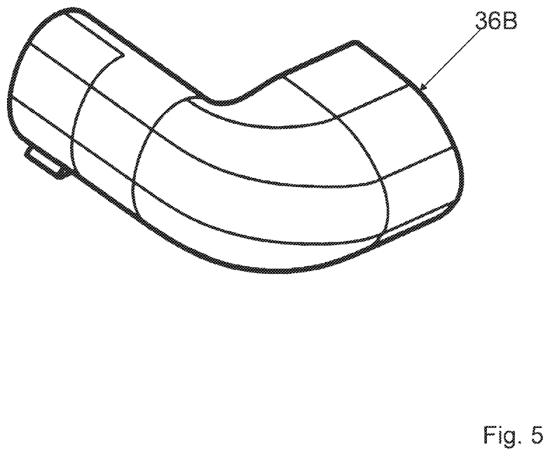

FIG. 5 is a perspective view of an isolated corner piece of the weatherstrip arrangement.

FIG. 1 shows a vehicle roof 10 which is configured as a panoramic roof and which has a roof cutout 12 fillable by a solid roof element 14 attached to the vehicle and by a displaceable cover element 16.

Solid roof element 14 and cover element 16 are parts of a module-type insert 18 of vehicle roof 10, module-type insert 18 being illustrated on its own in FIGS. 2 and 3. Insert 18 comprises a roof frame 20 via which it is attached to the vehicle structure and which is a support for solid roof element 14 and cover element 16. Additionally, roof frame 20 defines a roof opening 22 which can be closed by displaceable cover element 16.

Cover element 16 is part of a roof opening system and can be displaced between a closed position (FIG. 2), in which roof opening 22 is closed, and an open position (FIG. 3), in which roof opening 22 is at least partially open, by means of displacement kinematics 24. In the open position, cover element 16 is at least partially moved on top of solid roof element 14. In the closed position, cover element 16 is disposed forward of solid roof element 14, which means that it closes roof opening 22, which is also disposed forward of solid roof element 14, in this case, cover element 16 is flush with solid roof element 14,

Displacement kinematics 24 comprise a kinematic unit on either side of a vertical longitudinal center roof plane, each kinematic unit having a raising lever 26 which can be raised or pivoted to lift cover element 16. When cover element 16 is being displaced between the closed position and the open position, raising levers 26 are each moved in the longitudinal roof direction in a guide rail formed on respective lateral longitudinal leg 28A or 28B of roof frame 20. Raising levers 26 are each shifted along a respective lateral edge of solid roof element 14 in the process,

At its lateral edges on either side of vertical longitudinal center roof plane and at its front edge, solid roof element 14 is provided with a weatherstrip arrangement 30, which is shown on its own in FIG. 4. Weatherstrip arrangement 30 has a transverse leg 32 with which the rear edge of cover element 16 is in contact when cover element 16 is in its closed position. Additionally, weatherstrip arrangement 30 has two longitudinal legs 34A and 34B which are connected to the lateral edges of solid roof element 14 and on which respective raising levers 26 of displacement kinematics 24 slide when cover element 16 is being shifted, So weatherstrip arrangement 30 with its longitudinal legs 34A and 34B and its transverse leg 32 has a U-shape.

Longitudinal legs 34A and 34B and transverse leg 32 are each realized as an extruded profile and made of a TPV material blended with a low-friction additive, such as graphite, PTFE, PFPE, silicone, polyurethane, polyurethane dispersions, carbon black and/or the like.

Longitudinal legs 34A and 34B are connected to transverse leg 32 via corner pieces 36A and 36B, respectively. So corner pieces 36A and 36B each form a connecting element. between the respective extruded profiles.

Corner pieces 36A and 36B are connected to transverse leg 32 and longitudinal legs 34A and 34B in a form-fining and material-bonded manner by vulcanization.

In order to keep the wear of weatherstrip arrangement 30 by the forces exerted by raising levers 26 low, corner pieces 36A and 36B are each made of an elastomer—a thermoplastic vulcanizate in the case at hand—which is blended with a low-friction additive, which comprises in particular graphite, PTFE and/or a lubricating oil. The low-friction additive is dispersed in the volume of the elastomer with the result that weatherstrip arrangement 30 does not have to be additionally painted with an anti-friction coating or the like.

### Reference signs

10 vehicle roof

12 roof cutout

14 solid roof element

16 cover element

18 insert

20 roof frame

22 roof opening

24 displacement kinematics

26 raising lever

28A, B longitudinal leg

30 weatherstrip arrangement

32 transverse leg

34A, B longitudinal leg

36A, B corner piece

1. An openable vehicle roof comprising:
a solid roof element,
a roof opening disposed forward of the solid roof element, and
a roof opening system having a cover element configured to be displaced between a closed position, in which the cover element closes the roof opening, and an open position, in which the roof opening is at least partially open, by displacement kinematics,
the solid roof element having a weatherstrip arrangement at its front edge and at its lateral edges disposed on either side of a vertical longitudinal center roof plane,
the front edge of the cover element abutting a transverse leg of the weatherstrip arrangement of the solid roof element when the cover element is in the closed position, and
the displacement kinematics comprising a kinematic unit on either side of the vertical longitudinal center roof plane, each kinematic unit having a raising lever which slides on a respective longitudinal leg of the weatherstrip arrangement when the cover element is being displaced in the longitudinal roof direction,
wherein that the longitudinal legs of the weatherstrip arrangement are each connected to the transverse leg via a corner piece made of an elastomer blended with a low-friction additive.

2. The openable vehicle roof according to claim 1, wherein the elastomer is a thermoplastic elastomer.

3. The openable vehicle roof according to claim 1, wherein the elastomer comprises an EPDM (ethylene propylene diene rubber).

4. The openable vehicle roof according to claim 1, wherein the low-friction additive is selected from the group consisting of graphite, PTFE, PFPE, silicone, polyurethane, polyurethane dispersions, carbon black, an oil, a polyolefin wax, a soap, and combinations thereof.

5. The openable vehicle roof according to claim 1, wherein the longitudinal legs and the transverse leg are each formed by a weatherstrip profile.

6. The openable vehicle roof according to claim 1, wherein the corner pieces are each connected to one of the longitudinal legs and to the transverse leg by vulcanization.

7. The openable vehicle roof according to claim 1, wherein the longitudinal legs are each made of an elastomer blended with a low-friction additive.

8. The openable vehicle roof according to claim 1, wherein the transverse leg is made of an elastomer blended with a low-friction additive.

9. The openable vehicle roof according to claim 2, wherein the thermoplastic elastomer is a thermoplastic vulcanizate.
